(19) United States
(12) Patent Application Publication
(10) Pub. No.: US 2008/0043194 A1
(43) Pub. Date: Feb. 21, 2008

(54) Optical display module with heat sink structure

(75) Inventors: Ming-Chuan Lin, Taichung City (TW); Hsing-Fa Wang, Taichung County (TW); Chin-Ming Hsu, Changhua County (TW); Kuei-Ting Lu, Changhua County (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 11/503,953

(22) Filed: Aug. 15, 2006

(51) Int. Cl. G02F 1/1345

(52) U.S. Cl. 349/149

(57) ABSTRACT

An optical display module includes a liquid crystal panel, a driving IC, a flexible printed circuit board, a plurality of first pads, a plurality of second pads, at least a light source and a heat conductive member. The driving IC is provided on the liquid crystal panel and electrically connected to the flexible printed circuit board. The flexible printed circuit board includes through holes open at opposite sides. The first and second pads are provided on the opposite sides of the flexible printed circuit board respectively and connected to each other through the through holes. The light source electrically connected to the first pads. The heat conductive member is attached on the second pads. Heat of the light source is conducted to the heat conductive member through the first pads and the second pads in sequence to reduce the temperature around the light source.

### BACKGROUND OF THE INVENTION

1. Field of the Invention

The invention relates generally to an optical display module, and more particularly to an optical display module with a heat sink structure, which may prevent the heat of light source causing problems of display.

2. Description of the Related Art

The electric products, such as cellular phones, are designed to have smaller size and multifunction. The more functions of the cellular phone means that more electric items have to be provided in the cellular phone. However, the smaller cellular phone only has limited space therein, such that the electric items are arranged crowdedly in the space. The heat generated by the work of electric items will affect the function of the neighboring items.

FIG. 1 shows a liquid crystal display (LCD) module 1 of a cellular phone, in which a driving IC 2 is provided on a liquid crystal panel 3. A LED 4 is provided on a flexible printed circuit board (FPC) 5. The FPC 5 is bent toward a light guide plate 6 with the LED 4 adjacent to the driving IC 2. The driving IC 2 controls the liquid crystal panel 3 to show image and further includes a temperature comprehensive circuit to sense the temperature of the liquid crystal panel 3 and adjust the temperature that may affect the liquid crystal molecules that the liquid crystal panel 3 may keep a well displaying function. To have a well displaying function, it may provide the LED 4 with higher luminance to enhance the backlight of the liquid crystal panel 3. As higher luminance as the LED 4 has, it generates greater heat. For the LCD module of FIG. 1, the driving IC 2, which is next to the LED 4, is affected by the heat of the LED 4 most that affects the correction of sensing the temperature of the liquid crystal panel 3. In such condition the driving IC 2 may provide the liquid crystal panel 3 with an incorrect comprehensive action that could make the liquid crystal panel 3 malfunction in displaying images. In addition, the LED 4 may generate greater heat when it is turned on because that the package thereof has a worse heat conduction property that also may affect the correction of sensing the temperature of the liquid crystal panel 3.

### SUMMARY OF THE INVENTION

The primary objective of the invention is to provide an optical display module, which effectively disperses the heat from the light source and reduce the temperature around the light source.

The secondary objective of the invention is to provide an optical display module, which fixes the problem of incorrectly sense of the temperature by the driving IC in the liquid crystal panel that may cause malfunction of the liquid crystal panel.

According to the objectives of the invention, an optical display module includes a liquid crystal panel, a driving IC provided on the liquid crystal panel, a flexible printed circuit board electrically connected to the driving IC, a plurality of first pads, a plurality of second pads, at least a light source and a heat conductive member. The flexible printed circuit board includes a plurality of through holes in which heat conductive material disposed such as metal material. The first and second pads are provided on the front and rear surface of the flexible printed circuit board respectively and connected to each other through the through holes. The light source electrically connected to the first pads for transmitting the heat from the light source to the first pad. The heat conductive member is attached on the second pads. Whereby the heat generated from the light source may be conducted to the heat conductive member through the first pads and the second pads in sequence to reduce the temperature around the light source.

### BRIEF DESCRIPTION OF THE DRAWINGS

FIG. 1 is a sectional view of the conventional LCD module;

FIG. 2 is an exploded view of a preferred embodiment of the invention;

FIG. 3 is a back view of FIG. 2;

FIG. 4 is a sectional view of the first preferred embodiment of the invention in combination;

FIG. 5 is an enlarge view of a part of FIG. 4;

FIG. 6 is similar to FIG. 2, showing the optical display module further including a metal frame;

FIG. 7 is a sectional view of FIG. 6 in combination;

FIG. 8 is an exploded view of another preferred embodiment of the invention;

FIG. 9 is a back view of FIG. 8, showing the liquid crystal panel and the FPC; and

FIG. 10 is a sectional view of FIG. 8 in combination.

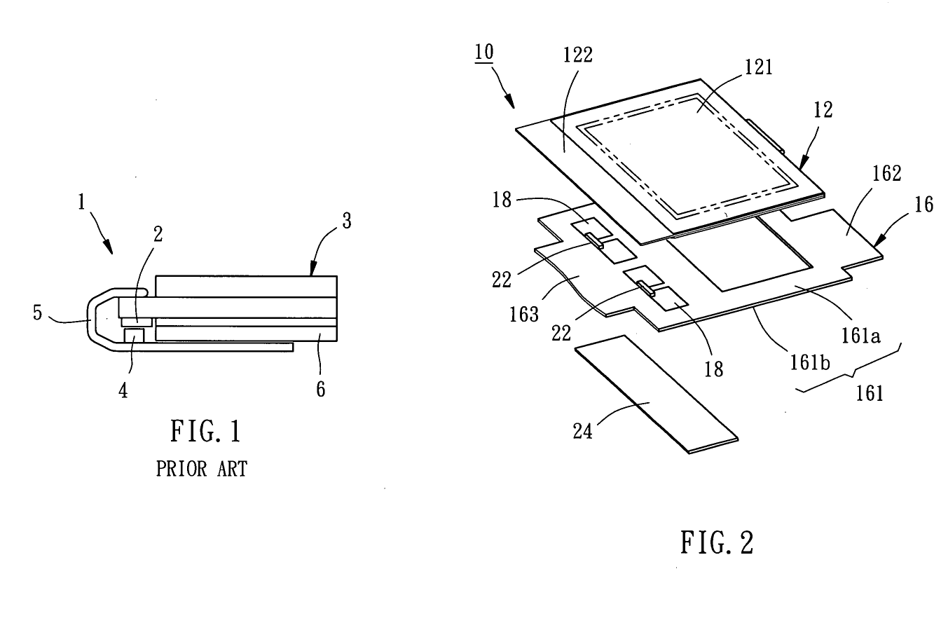

### DETAILED DESCRIPTION OF THE INVENTION

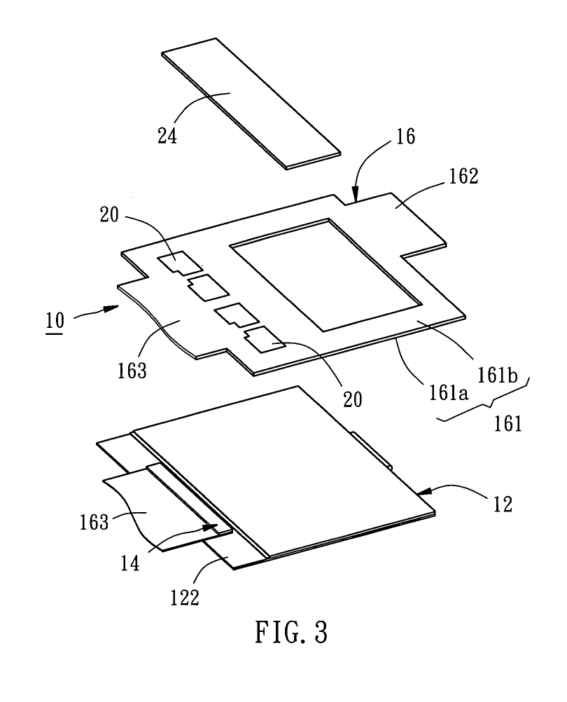

FIG. 2 to FIG. 5 show an optical display module 10 of the first preferred embodiment of the invention, which includes a liquid crystal panel 12, a driving IC 14, a flexible printed circuit board (FPC) 16, four first pads 18, four second pads 20, two light source 22, which are light emitting diodes (LEDs) in the drawings, and a heat conductive member 24.

The liquid crystal panel 12 includes a display region 121 and a non-display region 122 side by side. The driving IC 14 is disposed on the non-display region 122 of the liquid crystal panel 12, in which a temperature comprehensive circuit (not shown) is provided to sense a temperature of the liquid crystal panel 12. The temperature comprehensive circuit may adjust some factors such as voltage of the liquid crystal panel 12 to reduce the unwanted affection to the liquid crystal molecules.

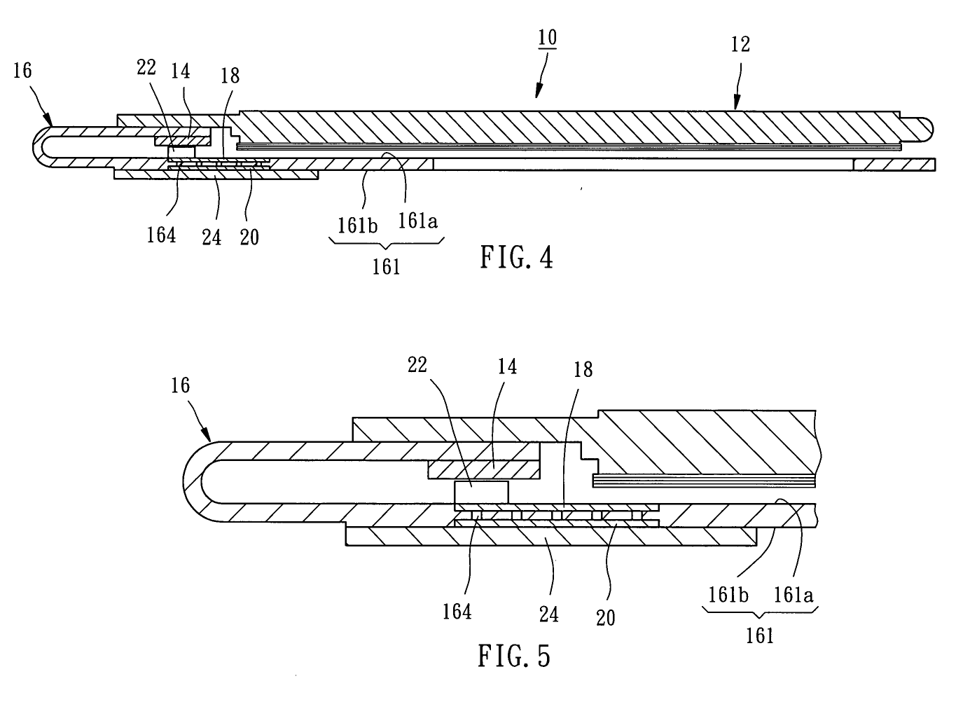

The FPC 16 has a flexible substrate 161, on which an input terminal 162 and an output terminal 163 are provided at opposite ends thereof. The input terminal 162 is electrically connected to a rigid system PCB (not shown), and the output terminal 163 is electrically connected to the driving IC 14. The FPC 16 is bent to be placed at a rear side of the liquid crystal panel 12 so that the LED 22 closes to the driving IC 14, as shown in FIG. 4 and FIG. 5. The flexible substrate 161 has a plurality of through holes 164, which are open from the front surface 161a to the rear surface 161b of the flexible substrate 161, adjacent to the output terminal 163. Each of through holes 164 is filled with heat conductive material such as metal material, or the inner wall of the through hole is coated with a heat conductive material.

The first pads 18 are provided on the front surface 161a of the flexible substrate 161 in a two-pair pattern to cover the through holes 164. Each pair of the first pads 18 is connected to a LED 22.

The second pads 20 are provided on the rear surface 161b of the flexible substrate 161 in a two-pair pattern and are connected to the first pads 18 by the way of the through holes 164.

Each connecting area between one LED 22 and corresponding first pad 18 is much less than that of the first pad 18 and the second pad 20.

The heat conductive member 24 is a rectangular plate made of a material with high heat conduction and electricity insulation properties. The heat conductive member 24 is attached on the rear surface 161b of the flexible substrate 161 so that the heat conductive member 24 totally covers the second pads 20.

The description mentioned above is related to the elements and structure of the optical display module 10 of the first preferred embodiment of the invention, and the functions are disclosed hereunder.

When the LEDs 22 are turned on and generate heat, the heat is conducted to the first pads 18 through the connecting portions between the LEDs 22 and the first pads 18. Because the areas of the first pads 18 are much greater than the connecting areas between the LEDs 22 and the first pads 18, they effectively increase the speed of reducing heat. Further, the first pads 18 conduct the heat to the heat conductive member 24 through the corresponding second pads 20. Likewise, the areas of the second pads 20 are much greater than the connecting areas between the LEDs 22 and the first pads 18. The heat is dissipated into the ambient air by the surface of the heat conductive member 24 or by the gap between the second pads 20 and the heat conductive member 24. The aforementioned reducing temperature mechanism not only reduces the temperature around the LEDs 22 quickly but also prevents the false sense of the temperature comprehensive circuit of the driving IC 14 such that the incorrect temperature comprehensive action on the liquid crystal panel 12 would not happens.

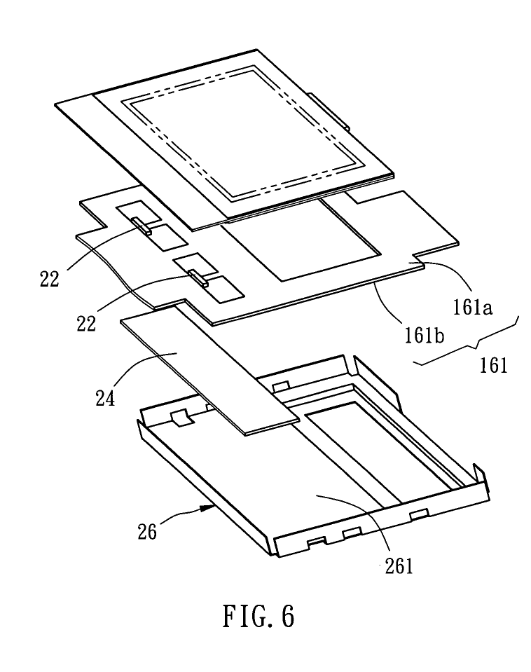

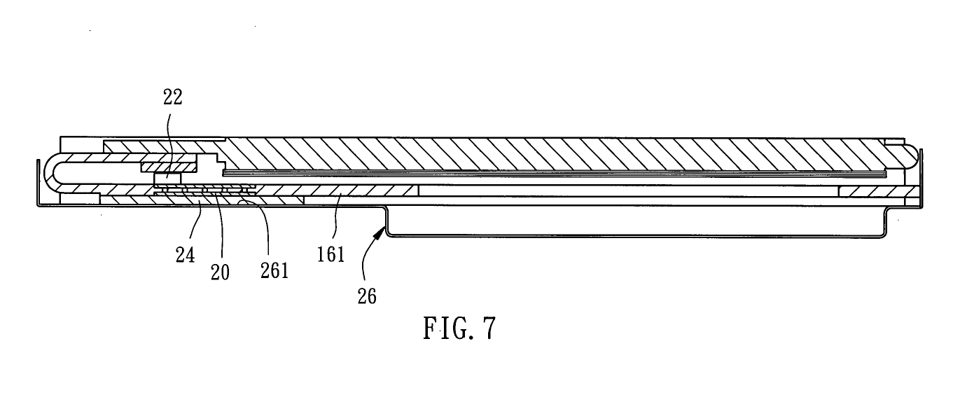

It is noted that the optical display module 10 of the invention may further includes a metal frame 26, as shown in FIG. 6 and FIG. 7. The metal frame 26 covers the flexible substrate 161, which has an interior surface 261 contacting the heat conductive member 24. Therefore, the metal frame 26 further conducts the heat from the heat conductive member 24 to the ambient air. In conclusion, the heat sink structure of the optical display module 10 of the invention dissipate the heat generated from the LEDs 22 out by several heat sink items that reduce the temperature around the LEDs 22.

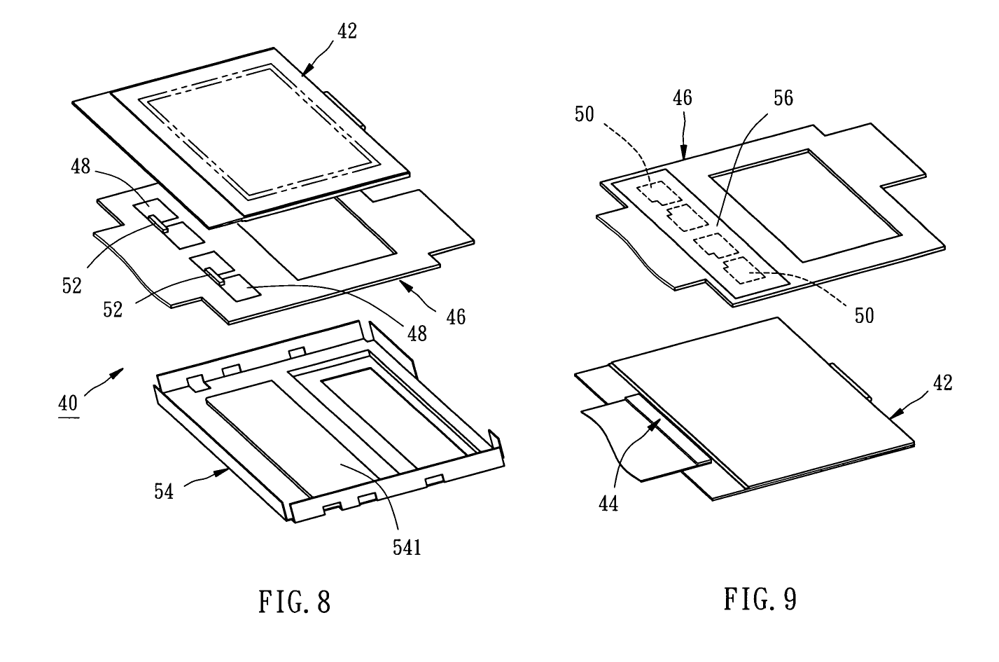

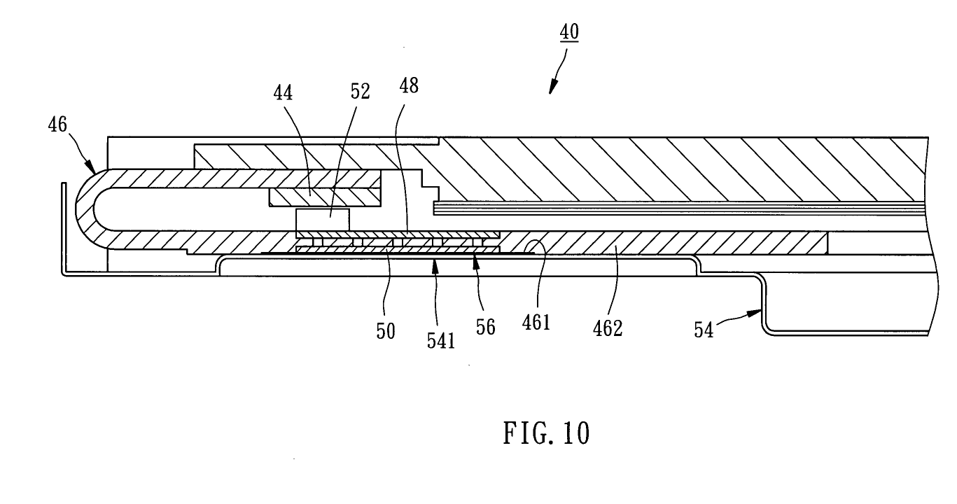

FIG. 8 to FIG. 10 show an optical display module 40 of the second preferred embodiment of the invention, which is similar to the first preferred embodiment. The optical display module 40 includes a liquid crystal panel 42, a driving IC 44, a FPC 46, four first pads 48, four second pads 50, two LEDs 52 and a metal frame 54. The optical display module 40 further includes a covering film 56 made of polyimide provided in an indentation portion 461 on the FPC 46. The covering film 56 covers the second pads 50 to form a flat surface on the flexible substrate 462 of the FPC 46. The metal frame 54 further includes a dispression portion 541, which is a curved inward portion, pressing the covering film 56 when the metal frame 54 is mounted. This structure has a shorter heat conduction path than that of FIG. 7 to get a better heat sink capacity because the thickness of the covering film 56 is much thinner than that of heat conductive member 24. in addition, the covering film 56 isolates the second pads 50 from the metal frame 54 to protect the second pads 50. The covering film 56 may prevents the second pads 50 from scratch and peeling when it has to disassemble the metal frame 54 that may prevent the copper foil of the FPC 46 from oxidation.

The description above is a few preferred embodiments of the invention and the equivalence of the invention is still within the scope of the claim of the invention.

What is claimed is:

1. An optical display module, comprising:
a liquid crystal panel;
a driving integrated circuit provided on the liquid crystal panel and electrically connected to the liquid crystal panel;
a flexible printed circuit board having a plurality of first pads on one surface thereof near the driving integrated circuit, a plurality of second pads on the opposite surface thereof, and a plurality of through holes connecting the first pads and the second pads, the flexible printed circuit board being electrically connected to the driving integrated circuit;
at least a light source electrically connected to the first pads; and
a heat conductive member disposed on the second pads of the flexible printed circuit board.

2. The optical display module as defined in claim 1, wherein an area of the light source connecting the first pad is smaller than an area of the first pad.

3. The optical display module as defined in claim 1, wherein an area of the light source connecting the first pad is smaller than an area of the second pad.

4. The optical display module as defined in claim 1, wherein the light source is a light emitting diode.

5. The optical display module as defined in claim 1, further comprising a metal frame coupled with the flexible printed circuit board and contacting the heat conductive member.

6. An optical display module, comprising:
a liquid crystal panel;
a driving IC provided on the liquid crystal panel and electrically connected to the liquid crystal panel;
a flexible printed circuit board having a plurality of first pads on one surface thereof near the driving integrated circuit, a plurality of second pads on the opposite surface thereof, and a plurality of through holes connecting the first pads and the second pads, the flexible printed circuit board being electrically connected to the driving integrated circuit;
at least a light source electrically connected to the first pads;
a covering film provided on the flexible printed circuit board and covering the second pads; and
a metal frame coupled with the flexible printed circuit board and contacting the covering film.

7. The optical display module as defined in claim 6, wherein the covering film is made of polyimide.

8. The optical display module as defined in claim 6, wherein an area of the light source connecting the first pad is smaller than an area of the first pad.

9. The optical display module as defined in claim 6, wherein an area of the light source connecting the first pad is smaller than an area of the second pad.

10. The optical display module as defined in claim 6, wherein the light source is a light emitting diode.
